(19) United States
(12) Patent Application Publication
(10) Pub. No.: US 2026/0134365 A1
(43) Pub. Date: May 14, 2026

(54) REQUIREMENTS DOCUMENT GENERATION SYSTEM USING MACHINE LEARNING

(71) Applicant: International Business Machines Corporation, Armonk, NY (US)

(72) Inventors: Yuan Yuan Ding, Shanghai (CN); Kun Yan Yin, NINGBO (CN); Jing Zhang, Shanghai (CN); Shi Yun Liang, Shanghai (CN); Yu Pan, Shanghai (CN); Medhi Charafeddine, Chavannes-Pre-Renens (CH); Anthony Giordano, Detroit, MI (US)

(21) Appl. No.: 18/943,634

(22) Filed: Nov. 11, 2024

(51) Int. Cl. G06Q 10/0631; H04L 51/02

(52) U.S. Cl. CPC G06Q 10/06313; H04L 51/02

(57) ABSTRACT

An example operation includes one or more of extracting multiple checkpoints performed on one or more projects and extracting multiple answers corresponding to the multiple checkpoints from a domain knowledge base, filtering the multiple checkpoints and the multiple answers based on a filtering criteria associated with a system to generate a subset of checkpoints and a subset of answers, generating a refined subset of answers from the subset of answers based on execution of at least one generative machine learning (ML) model on the subset of checkpoints, and the subset of answers to the subset of checkpoints, and generating a document that includes objectives and recommendations for the system based on execution of the at least one generative ML model on the subset of checkpoints and the refined subset of answers.

### BACKGROUND

The present invention relates to retrieval-augmented generation (RAG) artificial intelligence, generative machine learning models, and using such artificial intelligence tools to facilitate system development.

### SUMMARY

One example embodiment provides a computer-implemented method that may include one or more of extracting multiple checkpoints performed on one or more projects and extracting multiple answers corresponding to the multiple checkpoints from a domain knowledge base, filtering the multiple checkpoints and the multiple answers based on a filtering criteria associated with a system to generate a subset of checkpoints and a subset of answers, generating a refined subset of answers from the subset of answers based on execution of at least one generative machine learning (ML) model on the subset of checkpoints, and the subset of answers to the subset of checkpoints, and generating a document that includes objectives and recommendations for the system based on execution of the at least one generative ML model on the subset of checkpoints and the refined subset of answers.

Another example embodiment provides a computer system that may include a processor set, a set of one or more computer-readable storage media, and program instructions, collectively stored in the set of one or more storage media, that cause the processor set to perform computer operations that may include one or more of extracting multiple checkpoints performed on one or more projects and extracting multiple answers corresponding to the multiple checkpoints from a domain knowledge base, filtering the multiple checkpoints and the multiple answers based on a filtering criteria associated with a system to generate a subset of checkpoints and a subset of answers, generating a refined subset of answers from the subset of answers based on execution of at least one generative machine learning (ML) model on the subset of checkpoints, and the subset of answers to the subset of checkpoints, and generating a document that includes objectives and recommendations for the system based on execution of the at least one generative ML model on the subset of checkpoints and the refined subset of answers.

A further example embodiment provides a computer program product that may include a set of one or more computer-readable storage media, and program instructions, collectively stored in the set of one or more computer-readable storage media, for causing a processor set to perform computer operations that may include one or more of storage media, that cause the processor set to perform computer operations that may include one or more of extracting multiple checkpoints performed on one or more projects and extracting multiple answers corresponding to the multiple checkpoints from a domain knowledge base, filtering the multiple checkpoints and the multiple answers based on a filtering criteria associated with a system to generate a subset of checkpoints and a subset of answers, generating a refined subset of answers from the subset of answers based on execution of at least one generative machine learning (ML) model on the subset of checkpoints, and the subset of answers to the subset of checkpoints, and generating a document that includes objectives and recommendations for the system based on execution of the at least one generative ML model on the subset of checkpoints and the refined subset of answers.

### BRIEF DESCRIPTION OF THE DRAWINGS

FIG. 1 is a diagram illustrating a computing environment according to an embodiment of the instant solution.

FIG. 2 is a diagram illustrating a process of generating a requirements document according to the examples and features of the instant solution.

FIG. 3A is a diagram illustrating a process of extracting checkpoints and answers from related projects according to examples and features of the instant solution.

FIG. 3B is a diagram illustrating a process of refining the answers based on execution of a machine learning model according to examples and features of the instant solution.

FIG. 3C is a diagram illustrating a process of conducting a chat session for additional user requirements of the system according to the examples and features of the instant solution.

FIG. 3D is a diagram illustrating a process of generating a document with requirements therein according to the examples and features of the instant solution.

FIG. 4A illustrates a flow diagram, according to example embodiments.

FIG. 4B illustrates a flow diagram, according to example embodiments.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

According to an aspect of the example embodiments, there is provided a computer-implemented method that includes extracting multiple checkpoints performed on one or more projects and extracting multiple answers corresponding to the multiple checkpoints from a domain knowledge base, filtering the multiple checkpoints and the multiple answers based on a filtering criteria associated with a system to generate a subset of checkpoints and a subset of answers, generating a refined subset of answers from the subset of answers based on execution of at least one generative machine learning (ML) model on the subset of checkpoints, and the subset of answers to the subset of checkpoints, and generating a document that includes objectives and recommendations for the system based on execution of the at least one generative ML model on the subset of checkpoints and the refined subset of answers. One technical advantage of the computer-implemented method is to generate the requirements of a system through automation and machine learning resulting in enhanced accuracy and efficiency, better user input handling, and the ability to scale actions related to a requirements generating system.

In some embodiments, the computer-implemented method may further include executing a chat session with a user associated with the multiple checkpoints, generating questions about the system, outputting the questions using a chatbot via a graphical user interface (GUI) of the chat session, and receiving responses to the questions via the GUI. One technical advantage of this feature is to receive user input by the system in an automated process conducted by a chatbot thereby further improving the data collected by the system.

In some embodiments, the computer-implemented method may further include generating a prompt that includes, the subset of checkpoints, the refined subset of answers, the questions about the system and the responses to the questions, wherein the generating the document further comprises executing the at least one generative ML model on the prompt to generate the document. One technical advantage of this feature is leveraging prompt engineering and generative AI to generate a requirements document using a combination of data including data from a knowledge base, data from a user, and the like.

In some embodiments, the computer-implemented method may further include receiving the filtering criteria input through a graphical user interface (GUI) of a software application, wherein the filtering criteria comprises requirements of the system. One technical advantage of this feature is to provide enhanced system-focused granularity of detail for system requirements generation.

In some embodiments, the computer-implemented method may further include clustering documents stored within the domain knowledge base into a plurality of clusters corresponding to a plurality of project types, and generating checkpoints and answers for each of the clusters. One technical advantage of this feature is to create checkpoints and answers from other systems related to other projects, without the need for manual intervention. This process can be scaled easily without a need for additional human involvement.

In some embodiments, the system may include a software system, and the filtering criteria may include at least one of software requirements and service requirements of the software system. One technical advantage of this feature is the dynamic filtering out of unrelated information from the process without the need for human involvement.

In some embodiments, the at least one ML model may include a pre-trained ML model, and the computer-implemented method may further include re-training the pre-trained ML model based on at least one of historical requirements, historical checks corresponding to historical requirements, historical answers corresponding to historical checks, and model feedback data. One technical advantage of this feature is the fine-tuning of the ML model to be more accurate, enabling the generation of more precise requirements within the document.

According to an aspect of the example embodiments, there is provided a computer system that includes a processor set, a set of one or more computer-readable storage media, and program instructions, collectively stored in the set of one or more storage media, for causing the processor set to perform operations that include extracting multiple checkpoints performed on one or more projects and extracting multiple answers corresponding to the multiple checkpoints from a domain knowledge base, filtering the multiple checkpoints and the multiple answers based on a filtering criteria associated with a system to generate a subset of checkpoints and a subset of answers, generating a refined subset of answers from the subset of answers based on execution of at least one generative machine learning (ML) model on the subset of checkpoints, and the subset of answers to the subset of checkpoints, and generating a document that includes objectives and recommendations for the system based on execution of the at least one generative ML model on the subset of checkpoints and the refined subset of answers. In one technical advantage of the computer system may allow, the requirements of a system can be generated through automation and machine learning, resulting in enhanced accuracy, better user input handling, and the ability to scale the process, all of which improve the efficiency and effectiveness of system development.

In some embodiments, the processor set may perform operations that include executing a chat session with a user associated with the multiple checkpoints, generating questions about the system, outputting the questions using a chatbot via a graphical user interface (GUI) of the chat session, and receiving responses to the questions via the GUI. One technical advantage of this feature is to receive user input by the system in an automated process conducted by a chatbot thereby further improving the data collected by the system.

In some embodiments, the processor set may perform operations that include generating a prompt that includes, the subset of checkpoints, the refined subset of answers, the questions about the system and the responses to the questions, wherein the generating the document further comprises executing the at least one generative ML model on the prompt to generate the document. One technical advantage of this feature is leveraging prompt engineering and generative AI to generate a requirements document using a combination of data including data from a knowledge base, data from a user, and the like.

In some embodiments, the processor set may perform operations that include receiving the filtering criteria input through a graphical user interface (GUI) of a software application, wherein the filtering criteria comprises requirements of the system. One technical advantage of this feature is to provide enhanced system-focused granularity of detail for system requirements generation.

In some embodiments, the processor set may perform operations that include clustering documents stored within the domain knowledge base into a plurality of clusters corresponding to a plurality of project types, and generating checkpoints and answers for each of the clusters. One technical advantage of this feature is to create checkpoints and answers from other systems related to other projects, without the need for manual intervention. This process can be scaled easily without a need for additional human involvement.

In some embodiments, the system may include a software system, and the filtering criteria may include at least one of software requirements and service requirements of the software system. One technical advantage of this feature is the dynamic filtering out of unrelated information from the process without the need for human involvement.

In some embodiments, the at least one ML model may include a pre-trained ML model, and the processor set may perform operations that include retraining the pre-trained ML model based on at least one of historical requirements, historical checks corresponding to historical requirements, historical answers corresponding to historical checks, and model feedback data. One technical advantage of this feature is the fine-tuning of the ML model to be more accurate, enabling the generation of more accurate requirements within the document.

According to an aspect of the example embodiments, there is provided a computer program product that includes a set of one or more computer-readable storage media, and program instructions, collectively stored in the set of one or more computer-readable storage media, for causing a processor set to perform computer operations that include extracting multiple checkpoints performed on one or more projects and extracting multiple answers corresponding to the multiple checkpoints from a domain knowledge base, filtering the multiple checkpoints and the multiple answers based on a filtering criteria associated with a system to generate a subset of checkpoints and a subset of answers, generating a refined subset of answers from the subset of answers based on execution of at least one generative machine learning (ML) model on the subset of checkpoints, and the subset of answers to the subset of checkpoints, and generating a document that includes objectives and recommendations for the system based on execution of the at least one generative ML model on the subset of checkpoints and the refined subset of answers. One technical advantage of the computer system may allow the requirements of a system to be generated through automation and machine learning, resulting in enhanced accuracy, better user input handling, and the ability to scale the process, all of which improve the efficiency and effectiveness of system development.

In some embodiments, the computer operations may further include executing a chat session with a user associated with the multiple checkpoints, generating questions about the system, outputting the questions using a chatbot via a graphical user interface (GUI) of the chat session, and receiving responses to the questions via the GUI. One technical advantage of this feature is to receive user input by the system in an automated process conducted by a chatbot thereby further improving the data collected by the system.

In some embodiments, the computer operations may further include generating a prompt that includes, the subset of checkpoints, the refined subset of answers, the questions about the system and the responses to the questions, wherein the generating the document further comprises executing the at least one generative ML model on the prompt to generate the document. One technical advantage of this feature is leveraging prompt engineering and generative AI to generate a requirements document using a combination of data including data from a knowledge base, data from a user, and the like.

In some embodiments, the computer operations may further include receiving the filtering criteria input through a graphical user interface (GUI) of a software application, wherein the filtering criteria comprises requirements of the system. One technical advantage of this feature is to provide enhanced system-focused granularity of detail for system requirements generation.

In some embodiments, the computer operations may further include clustering documents stored within the domain knowledge base into a plurality of clusters corresponding to a plurality of project types, and generating checkpoints and answers for each of the clusters. One technical advantage of this feature is to create checkpoints and answers from other systems related to other projects, without the need for manual intervention. This process can be scaled easily without a need for additional human involvement.

In some embodiments, the system may include a software system, and the filtering criteria may include at least one of software requirements and service requirements of the software system. One technical advantage of this feature is the dynamic filtering out of unrelated information from the process without the need for human involvement.

In some embodiments, the at least one ML model may include a pre-trained ML model, and the computer operations may further include retraining the pre-trained ML model based on at least one of historical requirements, historical checks corresponding to historical requirements, historical answers corresponding to historical checks, and model feedback data. One technical advantage of this feature is the fine-tuning of the ML model to be more accurate, enabling the generation of more accurate requirements in the document.

The system described herein may be hosted within a software application, a service, or the like, which may be hosted by a host platform such as a cloud platform, a web server, a database, or the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community with shared concerns (e.g., mission, security requirements, policy, and compliance considerations). It may be managed by organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

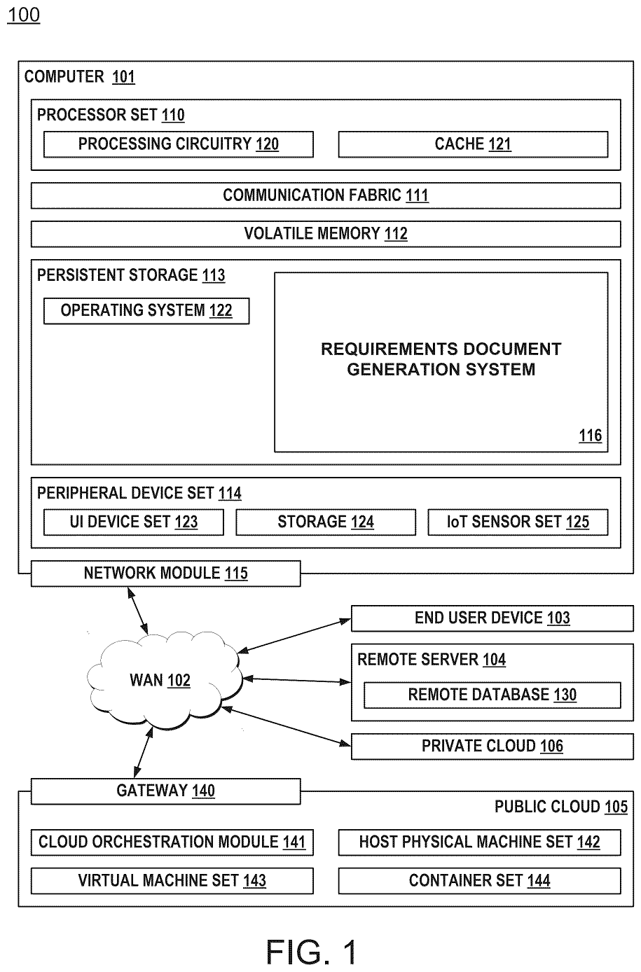

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as a requirements document generation system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Effective requirement gathering is fundamental to developing successful products and services, but it can be challenging. Systems often need input from multiple departments and stakeholders, which can be complex and time-consuming. Engaging the appropriate stakeholders early in the process is critical, but alignment can be difficult to achieve. Additionally, stakeholders may not fully understand their needs until they see a prototype, or they may lack awareness of potential requirements. Inadequate documentation of requirements can further lead to misinterpretations and errors during the design and manufacturing phases.

Presently, the process for generating business requirements relies heavily on manual communication and validation amongst users. Despite the rise of Large Language Models (LLMs), which has facilitated a more automated approach, the requirements often lack the granularity necessary within specific domains. These requirements tend to be generalized and face difficulty in precisely addressing the needs of a system or project. Even with the potential for automation, there remains a gap in achieving the level of specificity required for comprehensive business requirements. The generated requirements may be broad and struggle to precisely cover the diverse and nuanced needs of the system. It often necessitates extensive rounds of dialogue to cover a complete and accurate set of requirements.

The example embodiments are directed to a system that overcomes the drawbacks in the art and which relies on at least one machine learning (ML) model that includes a retrieval-augmented generator (RAG) architecture. This innovative approach integrates an external knowledge base to optimize the process of generating business requirements. By leveraging external knowledge, this solution aims to enhance the specificity and accuracy of the generated requirements, moving towards a more refined and user-centric approach in the business requirement generation process. The system can automatically generate business requirements based on machine learning to address the inaccuracies and incompleteness of traditional business requirements collection, improve collection efficiency, and further ensure accuracy and comprehensiveness of requirements.

The overall system may include four main modules. For example, a first module may be responsible for standard requirement generation which is used to collect requirement checkpoints (checks) from documents associated with related/historical projects which are stored within a domain knowledge base. The user may input a description of the system to be generated, and the first module may extract relevant documents associated therewith, and checks and answers to the checks from the relevant documents.

A second module may be used to refine the answers using machine learning. The machine learning model may adopt a retrieval-augmented generation (RAG) architecture that includes a retriever which can identify relevant documents/document chunks that are related to a checkpoint and then extract the related documents and document chunks. The extracted document data and the checkpoint may be added to a prompt that is input to the machine learning model. In response, the machine learning model can refine the answer that corresponds to the checkpoint based on the document content.

A third module is designed to collect input from a user of the system for one or more of the checkpoints. For example, the system may provide a chat application, chat service, or the like, which can output a chatbot that can converse with the user and collect user-specific details about the checkpoints and the answers for the system that is to be developed. The chat service may rely on a machine learning model, for example, a large language model (LLM), which can generate questions based on input content such as the checkpoints, the answers corresponding to the checkpoints, conversation content between the user and the chatbot, and the like.

A fourth module may be designed to generate a document with the requirements for the system being developed including the objectives of the system such as user requirements, system requirements, design requirements, and the like, as well as recommendations on the type of systems and designs to use. The document may be generated by a machine learning model with generative capabilities such as an LLM, or the like. The generated document may be a digital document with the content stored therein. Here, the machine learning model of the fourth module may ingest a prompt which includes a combination of the checkpoints, the answers, and the user chat history from the chatting with the chatbot, and generate the requirements for the digital document. The machine learning model may also generate the digital document with a description of the requirements therein.

Some of the benefits of the example embodiments include an overall workflow to generate system requirements based on customer needs and industry knowledge using machine learning, standard requirement checkpoint extraction based on historical documents and industry knowledge, a refinement engine based on a RAG architecture, and an interactive auto-agent that can converse with a user through a chatbot and collect user input data to further enhance and refine the requirements. The system may provide numerous advantages over traditional requirements generation processes including a decrease in overall efforts and cost to collect user requirements, easier tracking and management of the requirements, and ease in combining efforts from different stakeholders and channels.

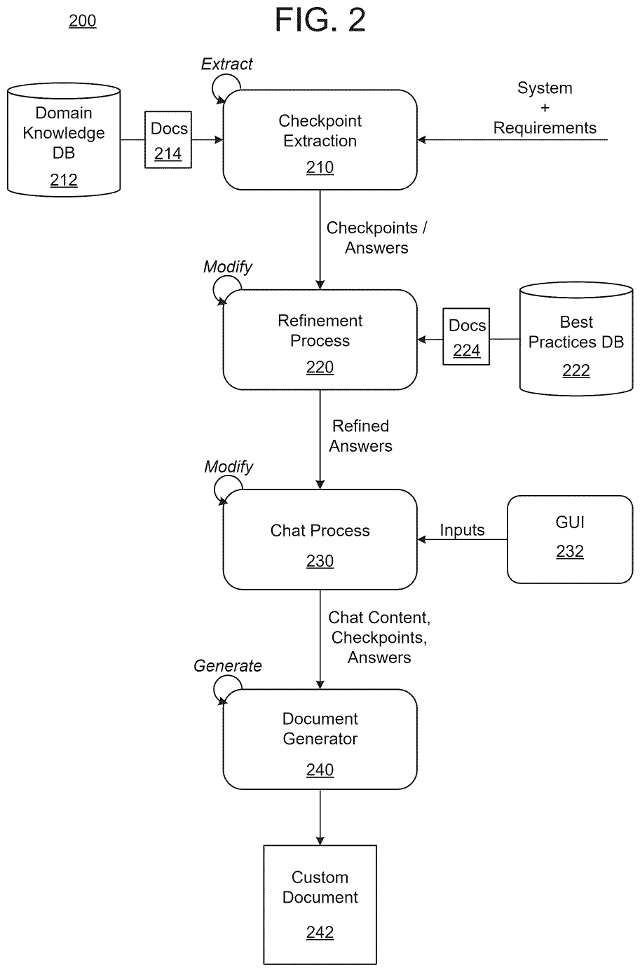

FIG. 2 illustrates a process 200 of generating a requirements document according to the examples and features of the instant solution. For example, the process 200 may be performed by a software application that is hosted by a host platform such as a cloud platform, a web server, an on-premises server, a database, a combination of systems, and the like. Referring to FIG. 2, during checkpoint extraction 210, the system executes a checkpoint extraction process. In the examples herein, a “checkpoint” refers to aspects of a system, component, process, etc. of the instant solution to be validated or checked. Examples of checkpoints for a software system designed to manage automatic payments may include types of payments that need to be supported, types of accounts that need to be supported, process steps of a transfer of funds, and the like.

The checkpoint extraction process may query a domain knowledge database 212 for documents 214 of related projects based on a description of the system that is provided from a user interface (not shown), or the like. However, it is not necessary for the description of the system to be provided. Instead, the checkpoint extraction process may extract all possible checkpoints and answers of prior systems of an organization, or the like. The checkpoint extraction process may also receive a description of the system and/or the requirements from a user interface and filter the checkpoints and the answers to generate a subset of checkpoints and a corresponding subset of answers that are related to the system and/or the requirements of the system that is to be developed. The result of the checkpoint extraction process is an initial subset (e.g., a plurality, etc.) of checkpoints and a corresponding subset of answers to the initial set of checkpoints.

During a refinement process 220, the system may perform a refinement process to refine the answers corresponding to the checkpoints based on a machine learning model that employs a RAG architecture. In this example, the machine learning model may receive the subset of checkpoints and the corresponding subset of answers from the checkpoint extraction 210, and refine the subset of answers based on additional knowledge included in documents 224 extracted from a database 222. For example, the documents 224 may contain best practices of an organization, in the field, etc. The RAG architecture may identify relevant documentation or document checks for each check/answer in the subset of checkpoints and answers and generate a prompt which includes the checkpoint, the answer, and the corresponding documentation. The prompt may be input to a generative machine learning model which, in response, generates a refined answer based on the corresponding documentation. This process may be performed sequentially for each answer to each checkpoint to refine each of the answers in the subset of answers based on organizational best practices, organizational needs, and the like.

During a chat process 230, an automated conversation may be performed with a user, or multiple users concurrently through a chat service that employs a chatbot within a chat window. In this example, the software may output a series of questions through a chatbot displayed on a graphical user interface (GUI) 232 of a software application such as a chat application. A user may respond to the questions with responses that include descriptive input content which includes answers to the series of questions provided by the chatbot.

In a next stage, a document generator 240 generates a document with the requirements of the system being developed. The subset of checkpoints and the refined answers may be input into a machine learning model with generative capabilities that can generate a document 242 which describes objectives and recommendations for the system. The ML model with the generative capabilities executes on the subset of checkpoints and the refined subset of answers to, in response, produce the document. The document may be stored in a database, displayed on a GUI, forwarded to an email address or other electronic address, and the like.

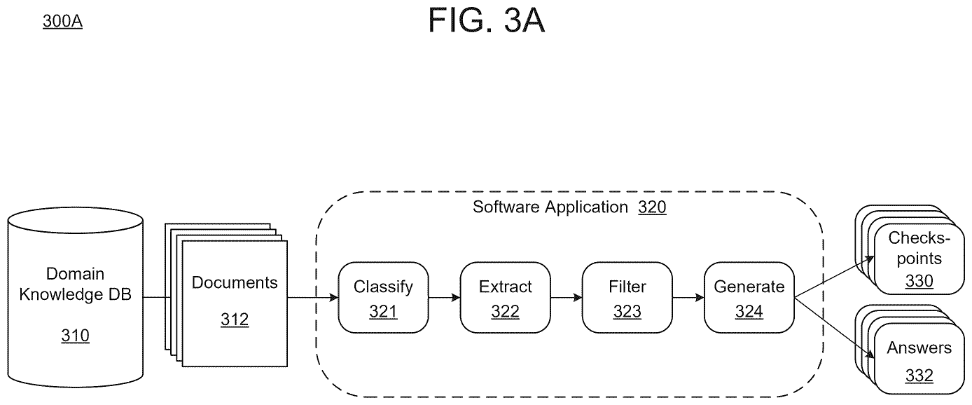

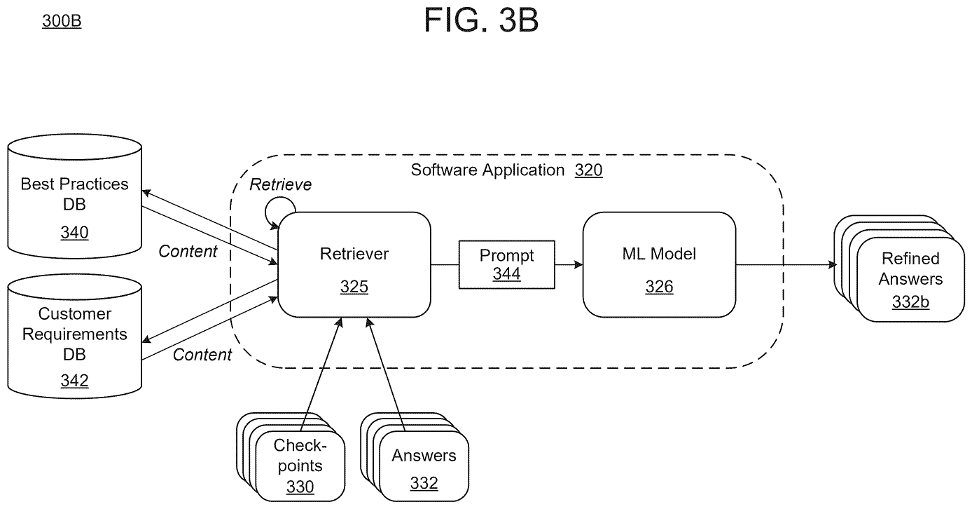

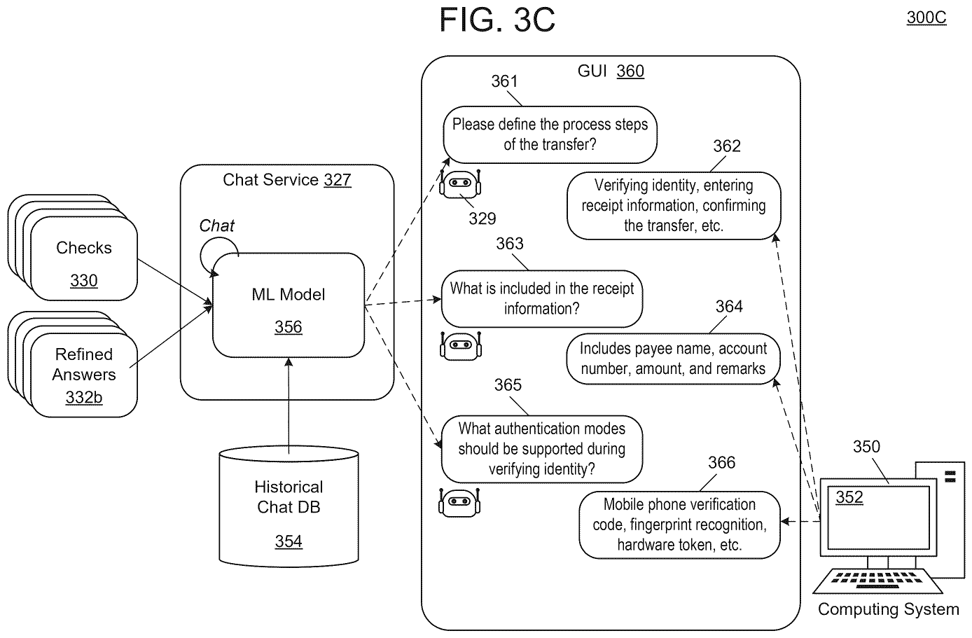

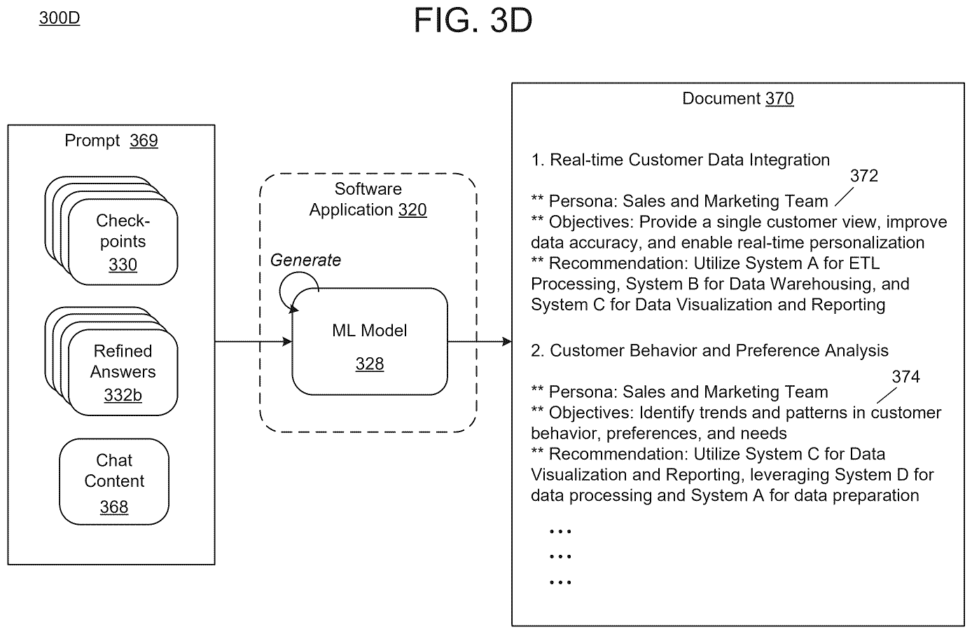

FIG. 3A illustrates a process 300A of extracting checkpoints and answers from related projects according to examples and features of the instant solution. The process 300A shown and described with respect to FIG. 3A corresponds to the checkpoint extraction process performed in checkpoint extraction 210 of the process of FIG. 2. Referring to FIG. 3A, a software application 320 may contain logic for generating a subset of checkpoints and answers from documents 312 that are extracted from a domain knowledge database 310. The software application 320 may query the domain knowledge database 310 for the documents 312 based on a description of the system to be developed, a description of requirements for the development, and the like. The returned documents 312 may be used to generate a subset of checkpoints and answers.

The software application 320 may extract multiple standard checkpoints and multiple corresponding answers to the multiple checkpoints related to current projects from the documents 312. In many cases, this may include a large number of currently or previously engaged projects and collected requirement documents, and the domain knowledge can be very helpful to generate standard requirement checkpoints and corresponding answers. The software application may perform a number of steps. For example, in 321, the software application 320 may classify a large number of domain knowledge documents according to domains. For example, the documents can be clustered by project name, document name, or the like, resulting in a plurality of clusters corresponding to a plurality of different projects, project types, and the like. In some embodiments, this classification portion includes machine learning semantic analysis of words of the domain knowledge documents to group the documents into one or more clusters.

In the extract process 322, the software application 320 may extract the checkpoint and answer related to each item or cluster. In the filter process 323, the software application 320 may receive input from a user interface that includes filtering criteria such as a description of the requirements of the system and filter the project cases related to the user input according to the user's input requirements and obtain the corresponding checkpoint/answer. The filtering process may be performed using text-based keywords that are used to identify relevant checkpoints/answers and irrelevant checkpoints/answers. In some embodiments, the filtering includes machine learning semantic analysis of words of the domain knowledge documents to identify and allow words which have different text or text roots but have a similar meaning, e.g., a similarity score within a threshold value. In this embodiment, words are embedded into a vector and cosine similarity may be used to compare vector similarity of terms. In the generate process 324, the software application may generate a subset of checkpoints 330 and a subset of answers 332 corresponding to the subset of checkpoints 330 from the initially generated checkpoints and answers based on the filtering criteria from the user's input and reference project checkpoint/answer. The output of the software application 320 is the subset of checkpoints 330 and the subset of answers 332 corresponding to the subset of checkpoints 330.

FIG. 3B illustrates a process 300B of refining the checkpoints and answers based on execution of a machine learning model according to examples and features of the instant solution. The process 300B shown and described with respect to FIG. 3B corresponds to the refinement process performed in 220 of the process of FIG. 2. Referring to FIG. 3B, the software application 320 further includes a RAG-based system including a retriever 325 and a ML model 326, such as an LLM. In this example, the retriever 325 may receive the subset of checkpoints 330 and the subset of answers 332 and identify documents or document chunks related to the subset of checkpoints. For example, the retriever 325 may perform the retrieval process for each check/answer.

For example, the retriever 325 may be an interface to a storage system such as a best practices database 340 and a customer requirements database 342. In this example, the best practices database 340 and the customer requirements database may be vector databases which store document content (e.g., chunks, pages, paragraphs, etc.) as vectors. The retriever may receive a string query as an input, and may return a list of vectors from the best practices database 340 and/or the customer requirements database 342 that match the string query in vector space.

The retriever 325 may take a check/answer and convert it into a vector in a vector space. Furthermore, the retriever may identify document content that corresponds to the check in vector space by performing a vector space comparison such as cosine similarity or the like on the vector of the check/answer and the vectors stored in the best practices database 340 and the customer requirements database 342. The resulting identified document content (e.g., vectors, etc.) may be paired together with the check/answer in a prompt 344 that is input to the ML model 326. The ML model 326 may generate a refined answer by modifying the answer by removing content, adding additional content, changing content, or the like, to further enhance the answer. This process may be repeated for each of the checkpoints and answers in the subset of checkpoints 330 and the subset of answers 332 resulting in a refined subset of answers 332b.

As an example, a checkpoint may ask for the required payments that need to be supported. Initially, the answer may include a bank transfer, credit card payments, debit card payments, mobile payments, e-wallet payments, etc. Based on the document content associated with the check/answer, the ML model 326 may modify the initial answer by removing the term “e-wallet payments” after determining that such payment types are not required. The result is a more accurate answer to the checkpoint. It should be appreciated that additional data may be added to the answer instead of removed, information may be both added and other information may be removed. The resulting refined answer is more accurate than the initial answer.

In this example, the retriever 325 can retrieve the documents associated with the user needs and pre-preprocess the documents to split documents into chunks and embed the chunks in vector space. Likewise, the subset of checkpoints and answers may be converted/embedded in vector space. Thus, the retriever 325 can perform a vector space comparison to identify relevant document content for each check/answer. The retrieval process may be performed sequentially (e.g., one by one, etc.) until each of the answers have been refined. The retrieved content and the check/answer may be added to a prompt that is designed based off of a prompt template. The prompt template may include a combination of static content that is common in each of the prompts, and dynamic content that is different based on the check/answer, and the document content.

FIG. 3C illustrates a process 300C of conducting a chat session for additional user requirements of the system according to the examples and features of the instant solution. The process 300C shown and described with respect to FIG. 3C corresponds to the chat process performed in 230 of the process of FIG. 2. In FIG. 3C, a user may input information about requirements, system data, etc. which can be collected through dialog with a chatbot 329 within a graphical user interface (GUI) 360 of a chat window/chat application. Generally, the granularity of the subset of checkpoints is coarse, and it is difficult to directly generate a precise checkpoint list to collect comprehensive information at one time. Therefore, inputs by users engaging with a chatbot which itself is a type of AI model and which also engages a machine learning model, can be used to improve the understanding of the requirements of the system.

Referring to FIG. 3C, the subset of checkpoints 330 and refined subset of answers 332b may be input to a ML model 356 of the chat service 327 along with dialog from a chat session between the user and the chatbot 329 from the GUI 360. In this example, a user may use a computing system 350 to connect to a host platform where the software application 320 is hosted. As an example, the computing system 350 may access the software application 320 at a web address hosted on the Internet, by inputting an IP address of the web address into a browser displayed on a display device 352 of the computing system 350. The software application 320 may include the chat service 327 which is configured to request additional data from the user via the chatbot 329 within the GUI 360 of the chat service 327.

For example, the ML model 356 may generate questions 361, 363, and 365, which are output by the chatbot 329 within the GUI. In response, the user may provide input data including answers 362, 364, and 366 to the questions 361, 363, and 365, respectively. The questions 361, 363, and 365 may be generated by the ML model 356 based on the checkpoints 330 and the refined answers 332b. For example, the ML model 356 may identify additional content that is missing from the refined answers 332b and ask the user about the missing content. As another example, the ML model 356 may receive chat content from the GUI 360 and ask questions based on what is being discussed during the chat window/GUI 360. As another example, the ML model 356 may receive historical chat content from a database 354 and use the historical chat content to ask questions to the user.

The user may input responses/answers to the questions by entering content into the GUI 360 of the chat service 327. The input content along with the questions asked may be sent from the chat service 327 to the ML model 356 and used to ask additional questions. For example, the ML model 356 may generate questions about checkpoints from the subset of checkpoints 330 which do not include answers, or which are otherwise missing some piece of information. As another example, the ML model 356 may generate questions based on the history of the conversation from the GUI 360, which may be input to the ML model 356. As another example, the ML model 356 may generate questions based on historical chat content from a database 354. The questions 361, 363, and 365, and the answers/responses 362, 364, and 366 may be aggregated together into chat content 368 (shown in FIG. 3D).

FIG. 3D illustrates a process 300D of generating a document with requirements therein according to the examples and features of the instant solution. The process 300D shown and described with respect to FIG. 3D corresponds to the document generation process performed in 240 of the process of FIG. 2. Referring to FIG. 3D, a generative model such as ML model 328 may receive, as input, the subset of checkpoints 330, the refined subset of answers 332b, and the chat content 368 (within a prompt) and generate a document 370 with a list of requirements to be performed for the system. The requirements may include identification of the teams involved, objectives of the system, design, etc., recommendations on systems to use, requirements, and the like.

According to various embodiments, the software application 320 may generate a prompt 369 which includes the subset of checkpoints 330, the refined subset of answers 332b, and the chat content 368. The prompt 369 may be generated based on a prompt template that includes additional content besides the checkpoints 330, the refined answers 332b, and the chat content 368. For example, the prompt 369 may include different parts including a first part which asks for fixed task descriptions (e.g., “You are a business analyst, please draft requirements, this is for host platform A, etc.”). A second part may include the subset of checkpoints 330 and the refined subset of answers 332b. A third part may include the chat messages from both the chatbot and the user from the GUI 360 in FIG. 3C. A fourth part may include a one-shot example such as “Description: Industry Scope, Functional area, and Business objectives, etc.”. Other parts are also possible, and these are just examples.

In the example of FIG. 3D, the ML model 328 receives the prompt 369 with the parts and generates a document 370 with the requirements of the system. Here, the document 370 includes a first requirement 372 for a first module of the system, and a second requirement 374 for a second module of the system. In some embodiments, the system may be a software system, and the modules may correspond to functionality to be carried out by the software system, backend sources to host the software, processing recommendations, storage recommendations, and the like. However, it should also be appreciated that the system may be a hardware system, and the requirements may include parts to use, functions to perform, and the like.

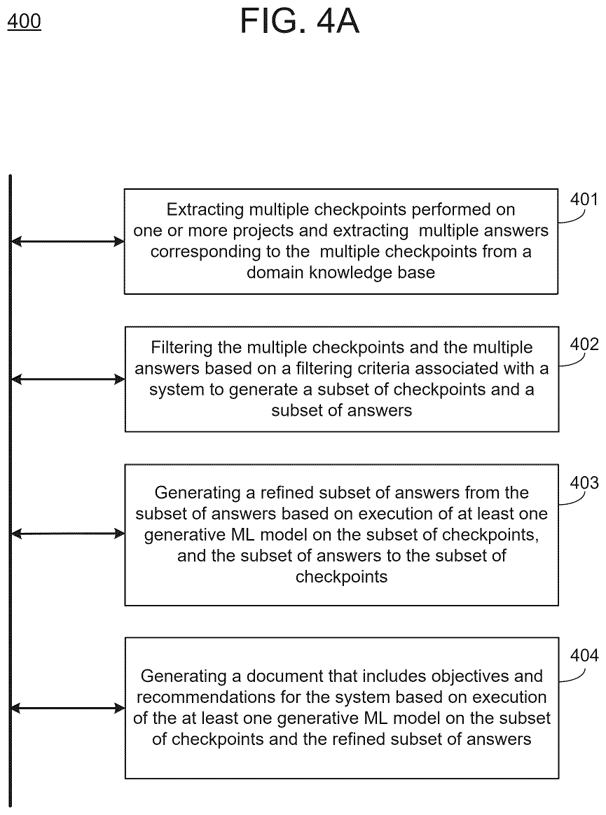

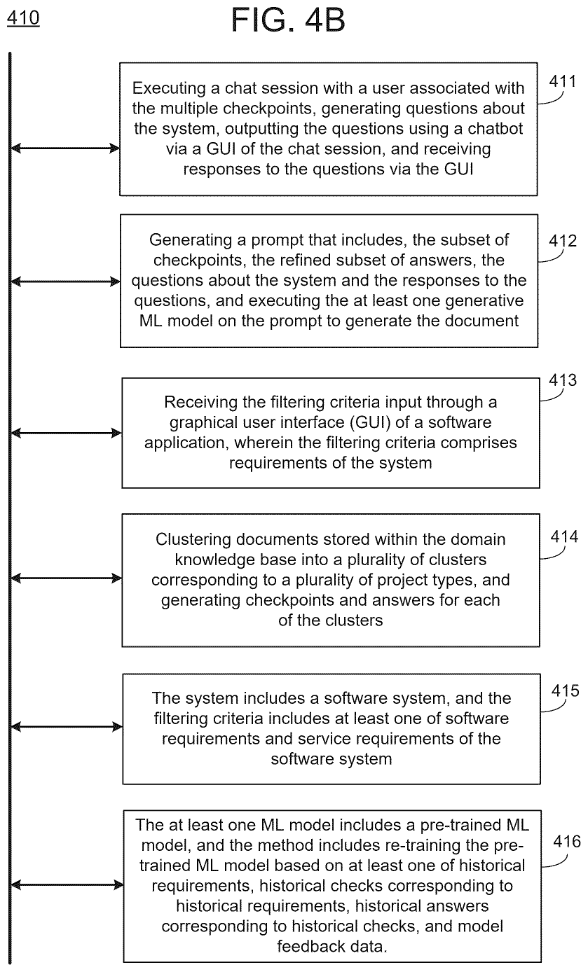

FIG. 4A illustrates a flow diagram of a method 400, according to example embodiments. Referring to FIG. 4A, the method 400 may include extracting multiple checkpoints performed on one or more projects and extracting multiple answers corresponding to the multiple checkpoints from a domain knowledge base in 401. The method may include filtering the multiple checkpoints and the multiple answers based on a filtering criteria associated with a system to generate a subset of checkpoints and a subset of answers in 402. The method may include generating a refined subset of answers from the subset of answers based on execution of at least one generative machine learning (ML) model on the subset of checkpoints, and the subset of answers to the subset of checkpoints in 403. The method may include generating a document that includes objectives and recommendations for the system based on execution of the at least one generative ML model on the subset of checkpoints and the refined subset of answers in 404.

FIG. 4B illustrates a flow diagram of a method 410, according to example embodiments. Referring to FIG. 4B, in 411, the method may include executing a chat session with a user associated with the multiple checkpoints, generating questions about the system, outputting the questions using a chatbot via a graphical user interface (GUI) of the chat session, and receiving responses to the questions via the GUI. In 412, the method may include generating a prompt that includes, the subset of checkpoints, the refined subset of answers, the questions about the system and the responses to the questions, wherein the generating the document further comprises executing the at least one generative ML model on the prompt to generate the document.

In 413, the method may include receiving the filtering criteria input through a graphical user interface (GUI) of a software application, wherein the filtering criteria comprises requirements of the system. In 414, the method may include clustering documents stored within the domain knowledge base into a plurality of clusters corresponding to a plurality of project types, and generating checkpoints and answers for each of the clusters. In 415, the system is a software system, and the filtering criteria may include at least one of software requirements and service requirements of the software system. In 416, the at least one ML model may include a pre-trained ML model, and the method may include re-training the pre-trained ML model based on at least one of historical requirements, historical checkpoints corresponding to historical requirements, historical answers corresponding to historical checkpoints, and model feedback data.

Detailed descriptions of training a machine learning model and executing a machine learning model are further described and depicted herein.

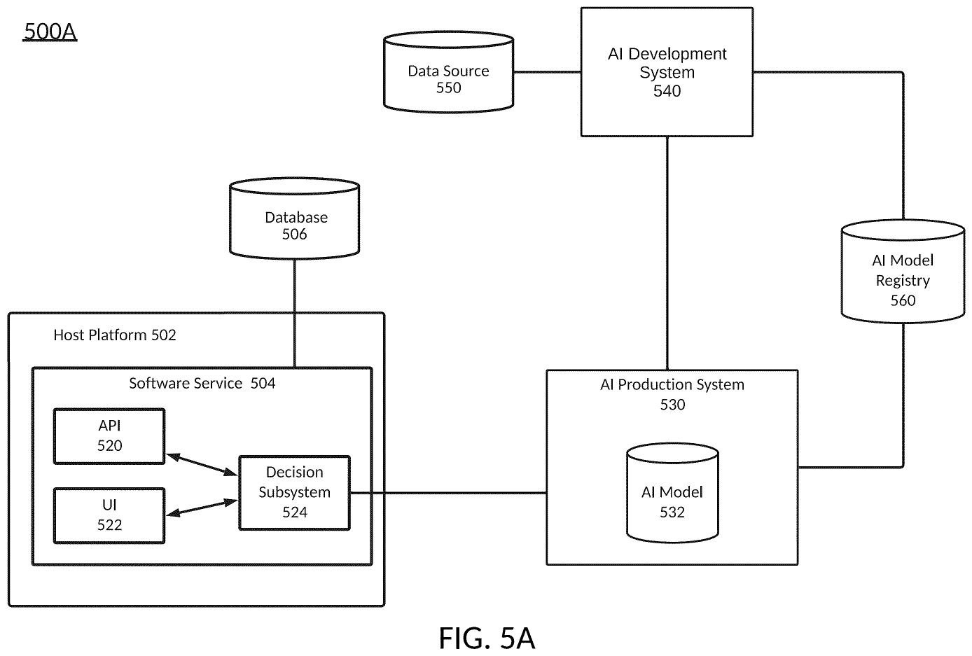

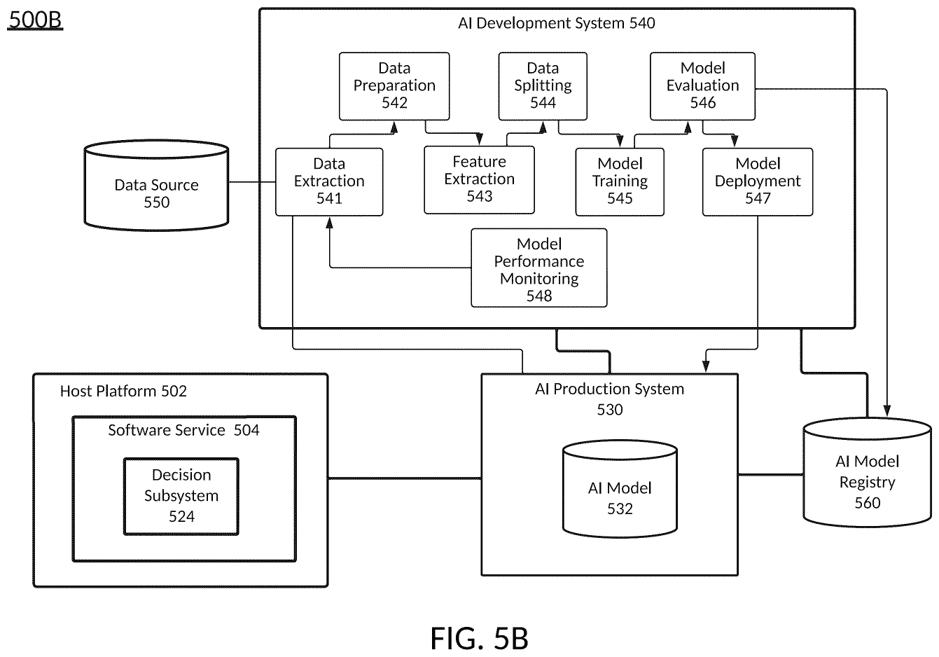

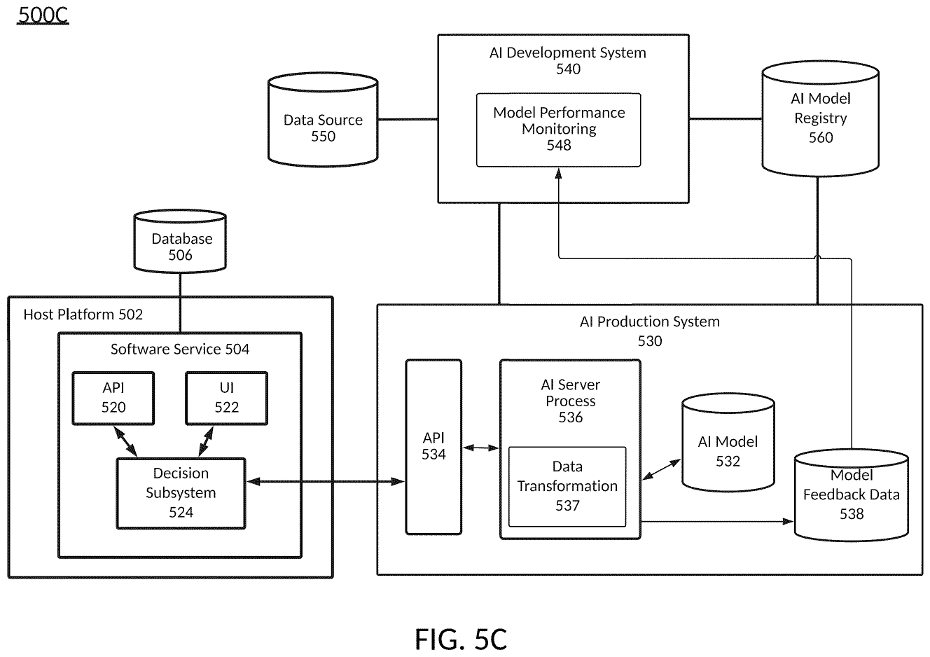

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies, and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI models refer to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content - such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive one car, for example, and without too much effort, could learn how to drive other types of vehicles such as other cars, a truck, or a bus. The foundation model is similarly used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks, and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning, and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications, and generating content in accessible formats.

LLMs may include abilities such as: text generation (language generation abilities, such as writing emails, blog posts or other mid-to-long form content in response to prompts that can be refined and polished. An example is a RAG-based architecture), content summarization (summarize long articles, news stories, research reports, corporate documentation and even interaction history into thorough texts tailored in length to the output format), AI assistants (chatbots that answer queries, perform backend tasks, and provide detailed information in natural language as a part of an integrated, self-serve solution for handling inquiries), code generation (assists developers in building applications, finding errors in code and uncovering security issues in multiple programming languages, “translating” between them, sentiment analysis (analyze text to determine a user's tone in order to understand user feedback at scale and aid in brand reputation management), and language translation (provides wider coverage to organizations across languages and geographies with fluent translations and multilingual capabilities).

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
extracting multiple checkpoints performed on one or more projects and extracting multiple answers corresponding to the multiple checkpoints from a domain knowledge base;
filtering the multiple checkpoints and the multiple answers based on a filtering criteria associated with a system to generate a subset of checkpoints and a subset of answers;
generating a refined subset of answers from the subset of answers based on execution of at least one generative machine learning (ML) model on the subset of checkpoints, and the subset of answers to the subset of checkpoints; and
generating a document that includes objectives and recommendations for the system based on execution of the at least one generative ML model on the subset of checkpoints and the refined subset of answers.

2. The computer-implemented method of claim 1, further comprising executing a chat session with a user associated with the system, generating questions about the system, outputting the questions using a chatbot via a graphical user interface (GUI) of the chat session, and receiving responses to the questions via the GUI.

3. The computer-implemented method of claim 2, further comprising generating a prompt that includes: the subset of checkpoints, the refined subset of answers, the questions about the system and the responses to the questions, wherein the generating the document further comprises executing the at least one generative ML model on the prompt to generate the document.

4. The computer-implemented method of claim 1, further comprising receiving the filtering criteria input through a graphical user interface (GUI) of a software application, wherein the filtering criteria comprises requirements of the system.

5. The computer-implemented method of claim 1, wherein the extracting comprises clustering documents stored within the domain knowledge base into a plurality of clusters corresponding to a plurality of project types, and generating checkpoints and answers for each of the clusters.

6. The computer-implemented method of claim 1, wherein the system comprises a software system, and the filtering criteria comprise at least one of software requirements and service requirements of the software system.

7. The computer-implemented method of claim 1, wherein the at least one ML model comprises a pre-trained ML model, and the computer-implemented method further comprises re-training the pre-trained ML model based on at least one of historical requirements, historical checkpoints corresponding to historical requirements, historical answers corresponding to historical checkpoints, and model feedback data.

8. A computer system comprising:
a processor set;
a set of one or more computer-readable storage media; and
program instructions, collectively stored in the set of one or more storage media, that cause the processor set to perform computer operations comprising:
extracting multiple checkpoints performed on one or more projects and extracting multiple answers corresponding to the multiple checkpoints from a domain knowledge base;
filtering the multiple checkpoints and the multiple answers based on a filtering criteria associated with a system to generate a subset of checkpoints and a subset of answers;
generating a refined subset of answers from the subset of answers based on execution of at least one generative machine learning (ML) model on the subset of checkpoints, and the subset of answers to the subset of checkpoints; and
generating a document that includes objectives and recommendations for the system based on execution of the at least one generative ML model on the subset of checkpoints and the refined subset of answers.

9. The computer system of claim 8, wherein the computer operations further comprise executing a chat session with a user associated with the system, generating questions about the system, outputting the questions using a chatbot via a graphical user interface (GUI) of the chat session, and receiving responses to the questions via the GUI.

10. The computer system of claim 9, wherein the computer operations further comprise generating a prompt that includes, the subset of checkpoints, the refined subset of answers, the questions about the system and the responses to the questions, wherein the generating the document further comprises executing the at least one generative ML model on the prompt to generate the document.

11. The computer system of claim 8, wherein the computer operations further comprise receiving the filtering criteria input through a graphical user interface (GUI) of a software application, wherein the filtering criteria comprises requirements of the system.

12. The computer system of claim 8, wherein the extracting comprises clustering documents stored within the domain knowledge base into a plurality of clusters corresponding to a plurality of project types, and generating checkpoints and answers for each of the clusters.

13. The computer system of claim 8, wherein the system comprises a software system, and the filtering criteria comprise at least one of software requirements and service requirements of the software system.

14. The computer system of claim 8, wherein the at least one ML model comprises a pre-trained ML model, and the computer operations further comprise re-training the pre-trained ML model based on at least one of historical requirements, historical checkpoints corresponding to historical requirements, historical answers corresponding to historical checkpoints, and model feedback data.

15. A computer program product comprising:
a set of one or more computer-readable storage media; and
program instructions, collectively stored in the set of one or more computer-readable storage media, for causing a processor set to perform computer operations comprising:
extracting multiple checkpoints performed on one or more projects and extracting multiple answers corresponding to the multiple checkpoints from a domain knowledge base;
filtering the multiple checkpoints and the multiple answers based on a filtering criteria associated with a system to generate a subset of checkpoints and a subset of answers;
generating a refined subset of answers from the subset of answers based on execution of at least one generative machine learning (ML) model on the subset of checkpoints, and the subset of answers to the subset of checkpoints; and
generating a document that includes objectives and recommendations for the system based on execution of the at least one generative ML model on the subset of checkpoints and the refined subset of answers.

16. The computer program product of claim 15, wherein the computer operations further comprise executing a chat session with a user associated with the multiple checkpoints, generating questions about the system, outputting the questions using a chatbot via a graphical user interface (GUI) of the chat session, and receiving responses to the questions via the GUI.

17. The computer program product of claim 16, wherein the computer operations further comprise generating a prompt that includes the subset of checkpoints, the refined subset of answers, the questions about the system and the responses to the questions, wherein the generating the document further comprises executing the at least one generative ML model on the prompt to generate the document.

18. The computer program product of claim 15, wherein the computer operations further comprise receiving the filtering criteria input through a graphical user interface (GUI) of a software application, wherein the filtering criteria comprises requirements of the system.

19. The computer program product of claim 15, wherein the extracting comprises clustering documents stored within the domain knowledge base into a plurality of clusters corresponding to a plurality of project types, and generating checkpoints and answers for each of the clusters.

20. The computer program product of claim 15, wherein the system comprises a software system, and the filtering criteria comprise at least one of software requirements and service requirements of the software system.
